(19) United States
(12) Patent Application Publication
(10) Pub. No.: US 2018/0244092 A1
(43) Pub. Date: Aug. 30, 2018

(54) ELECTROSTATICALLY ASSISTED PRINTING OF A PACKAGING LAMINATE FOR DIMENSIONALLY STABLE FOOD CONTAINERS INCLUDING THE FOLDED PACKAGING LAMINATE

(71) Applicant: SIG TECHNOLOGY AG, Neuhausen (CH)

(72) Inventors: Dirk Schibull, Baal (DE); Michael Wolters, Heinsberg (DE); Matias Daun, Jülich (DE)

(21) Appl. No.: 15/752,781

(22) PCT Filed: Aug. 12, 2016
(86) PCT No.: PCT/EP2016/069246

§ 371 Date: Feb. 14, 2018

(30) Foreign Application Priority Data
Aug. 14, 2015 (DE) 10 2015 010 406.3
May 30, 2016 (DE) 10 2016 209 349.5

(51) Int. Cl. B41M 1/10; B32B 15/04; B32B 15/20; B32B 27/08; B32B 27/10; B32B 27/30; B32B 27/32; B32B 29/00; B32B 38/00; B32B 7/12; B65D 5/06; B65D 5/42

(52) U.S. Cl. CPC B41M 1/10; B32B 2439/70; B32B 15/20; B32B 27/08; B32B 27/10; B32B 27/308; B32B 27/32; B32B 29/002; B32B 38/0008; B32B 38/145; B32B 7/12; B65D 5/064; B65D 5/4216; B32B 2255/12; B32B 2255/205; B32B 2264/102; B32B 2264/104; B32B 2307/206; B32B 2307/4023; B32B 2307/546; B32B 2307/732; B32B 15/04

(57) ABSTRACT

The invention relates to a process including, as steps a) provision of a sheetlike composite (200) including, as mutually superposed layers, from an external surface (201) of the sheetlike composite to an internal surface (202) of the sheetlike composite, i) a carrier layer, ii) a barrier layer, and iii) a polymeric internal layer, wherein the sheetlike composite (200) has a first electrical charge; b) provision of a first component (300) including a first component surface (301), wherein the first component surface (301) includes a plurality of recesses (302), wherein the recesses (302) include a composition (303) including a colourant, wherein the first component (300) moves in a first direction (304), wherein the first component (300) has a further electrical charge; c) increase of the absolute magnitude of the difference between the first electrical charge and the further electrical charge; and d) bringing the external surface (201) of the sheetlike composite into contact with the first component surface (301). The invention further relates to a printed sheetlike composite; to a container precursor, and also to a container, in each case including the printed sheetlike composite; to a device (500) for the printing of a sheetlike composite; and to a use of the device for the printing of a sheetlike composite.

The present invention relates to the technical field of dimensionally stable food containers made of packaging laminates, wherein these containers include the folded packaging laminate. The present invention in particular relates to a process including, as steps
a) provision of a sheetlike composite including, as mutually superposed layers, from an external surface of the sheetlike composite to an internal surface of the sheetlike composite,
   i) a carrier layer,
   ii) a barrier layer, and
   iii) a polymeric internal layer,
   wherein the sheetlike composite has a first electrical charge;
b) provision of a first component including a first component surface,
   wherein the first component surface includes a plurality of recesses,
   wherein the recesses include a composition including a colourant,
   wherein the first component moves in a first direction,
   wherein the first component has a further electrical charge;
c) increase of the absolute magnitude of the difference between the first electrical charge and the further electrical charge; and
d) bringing the external surface of the sheetlike composite into contact with the first component surface.

The invention further relates to a printed sheetlike composite; to a container precursor, and also to a container, in each case including the printed sheetlike composite; to a device for the printing of a sheetlike composite; and to a use of the device for the printing of a sheetlike composite.

The prior art discloses dimensionally stable food containers made of multilayer laminates, for which the term sheetlike composites is also used here. These containers are obtained by folding of, and sealing between, certain regions of the laminate. The dimensional stability of the container is achieved here in that the laminate includes a carrier layer, which often comprises paperboard or cardboard. Foods can be stored for a long period in these food containers with minimal impairment. The sheetlike composites are typically composed of the carrier layer, mostly composed of paperboard or of paper, an adhesion-promoter layer, a barrier layer and a further plastics layer, as disclosed inter alia in WO 90/09926 A2.

The containers described above usually have a printed decor on their external side. This can be used to provide, directly on the container, information relevant for the consumer of the food included in the container, an example being the ingredients of the food. The decor moreover serves for promotional purposes and serves to provide an attractive appearance to the product. The prior art applies the decor to the laminate via an intaglio printing process before the folding of the laminate. This is achieved by using a printing roll with a large number of recesses, known as cells. The cells contain a printing ink which is received by the laminate when the laminate surface to be printed is pressed into contact. The cells of the printing roll therefore correspond to the individual pixels of the printed decor. In order to achieve a printed image of the best possible quality, it is necessary that almost every cell applies sufficient printing ink to the laminate. If the laminate receives too little, or no, printing ink from a cell, the corresponding pixel is absent in the printed image. Another term used to describe this is “missing dots”. For an acceptable printed image there is a maximal acceptable proportion of missing dots. The number of missing dots produced during printing generally increases with the roughness of the laminate surface to be printed, for example a surface of a paperboard layer. Reception of the printing ink by the laminate here is rendered more difficult in that the liquid printing ink forms a meniscus in the cells. The surface of the printing ink in the cells is therefore concave, i.e. curved away from the laminate. This means that the only laminate surfaces that can be printed satisfactorily are those that do not exceed a certain roughness. The surface roughness of the laminate here is determined significantly by the paperboard layer. The paperboard layer therefore mostly requires complicated treatment in order to attain a laminate surface that is relatively smooth and that can be printed with good results. To this end, the paperboard layer is by way of example equipped with one or more coated layers. This leads to considerably increased costs in container production.

In general terms, it is an object of the present invention to overcome, at least to some extent, a disadvantage arising from the prior art. Another object of the invention is to provide a dimensionally stable food container made of a packaging laminate with a decor which exhibits an improved printed image. Another object of the present invention is to provide a dimensionally stable food container made of a packaging laminate with a decor, wherein the decor exhibits an equally good or improved printed image on a relatively rough printed surface. Another object of the invention is to provide a dimensionally stable food container made of a packaging laminate with a decor, wherein the decor has been printed directly onto a paperboard layer or paper layer of the packaging laminate. Another object of the invention is to provide a dimensionally stable food container made of a packaging laminate with a decor, wherein the decor has lower weight per unit area for the same area coverage. Another object of the invention is to provide a dimensionally stable food container made of a packaging laminate with a decor, wherein the decor has a wider area coverage range. Another object of the invention is to provide a dimensionally stable food container made of a packaging laminate with a decor, wherein the food container can be produced cheaper. Another object of the invention is to provide a dimensionally stable food container with one of the above advantages, wherein the decor has been obtained via intaglio printing. Another object of the invention is to provide one of the above advantageous dimensionally stable food containers made of a packaging laminate, wherein the packaging laminate includes an electrically conductive barrier layer, preferably made of aluminium.

The independent claims provide a contribution to achievement, at least to some extent, of at least one of the above objects. The dependent claims provide preferred embodiments which contribute to achievement, at least to some extent, of at least one of the objects.

An embodiment 1 of a process including, as steps,
a) provision of a sheetlike composite including, as mutually superposed layers, from an external surface of the sheetlike composite to an internal surface of the sheetlike composite,
   i) a carrier layer,
   ii) a barrier layer, and
   iii) a polymeric internal layer,
   wherein the sheetlike composite has a first electrical charge;
b) provision of a first component including a first component surface,
   wherein the first component surface includes a plurality of recesses,
   wherein the recesses include a composition including a colourant,
   wherein the first component moves in a first direction,
   wherein the first component has a further electrical charge;
c) increase of the absolute magnitude of the difference between the first electrical charge and the further electrical charge; and
d) bringing the external surface of the sheetlike composite into contact with the first component surface,
   contributes to achievement of at least one of the objects of the invention.

An inventive embodiment 2 of the process is designed according to the embodiment 1, wherein the process further includes a step of
e) reduction of the absolute magnitude of the difference between the first electrical charge and the further electrical charge downstream of the step d).

It is preferable that in step e) the sheetlike composite is earthed on the external surface. The reduction in step e) can be achieved by way of example by means of earthing or else of an electrode with electrical voltage opposite to that of the sheetlike composite.

An inventive embodiment 3 of the process is designed according to the embodiment 1 or 2, wherein the barrier layer is electrically insulating. The increase is preferably achieved here in step c) in that electrical charge carriers are applied from an electrode onto a further component, and the further component applies electrical charge carriers to the internal surface of the sheetlike composite via contact with the internal surface of the sheetlike composite. An electrical charge difference exists here between the first component and the further component.

An inventive embodiment 4 of the process is designed according to any of the preceding embodiments, wherein the increase in step c) is achieved via application of electrical charge carriers from an electrode onto the external surface of the sheetlike composite.

An inventive embodiment 5 of the process is designed according to embodiment 1, 2 or 4, wherein the barrier layer is electrically conductive.

An inventive embodiment 6 of the process is designed according to the embodiment 5, wherein the barrier layer includes a metal or a metal oxide or both, or in each case preferably consists thereof. A preferred metal is aluminium.

An inventive embodiment 7 of the process is designed according to any of the preceding embodiments, wherein the sheetlike composite has been brought into contact with a further component in step c) or d), or in both, wherein the further component moves in a further direction, wherein the further direction differs from the first direction. It is preferable here that the sheetlike composite has been brought into contact at its internal surface with the further component. It is preferable that the further component guides the sheetlike composite. It is preferable that the first direction is opposite to the further direction.

An inventive embodiment 8 of the process is designed according to any of the preceding embodiments, wherein the first component rotates, wherein the first direction is a first direction of rotation.

An inventive embodiment 9 of the process is designed according to the embodiment 7 or 8, wherein the further component rotates, wherein the further direction is a further direction of rotation.

An inventive embodiment 10 of the process is designed according to any of the preceding embodiments, wherein the sheetlike composite is printed in step d) via intaglio printing.

An inventive embodiment 11 of the process is designed according to any of the preceding embodiments, wherein the first component has been earthed.

An inventive embodiment 12 of the process is designed according to any of the preceding embodiments, wherein the sheetlike composite is characterized by an ignition residue in the range from 0.1 to 75 mg, preferably from 0.2 to 50 mg, most preferably from 0.3 to 30 mg.

An inventive embodiment 13 of the process is designed according to any of the preceding embodiments, wherein the sheetlike composite further includes a polymeric external layer on one side of the carrier layer, wherein the said side faces towards the external surface, wherein a layer thickness of the polymeric external layer is in the range from 1 to 30 μm, preferably from 2 to 25 μm, most preferably from 3 to 20 μm.

An inventive embodiment 14 of the process is designed according to any of the preceding embodiments, wherein the sheetlike composite is superimposed by a colour layer on the external surface in step d), wherein the colour layer is characterized by a number of absent matrix dots in the range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

An inventive embodiment 15 of the process is designed according to any of the preceding embodiments, wherein the sheetlike composite is superimposed on the external surface in step d) by a colour layer, wherein the colour layer includes a first colour layer region and a further colour layer region, wherein the first colour layer region is characterized by area coverage of at least 50%, preferably of at least 60%, more preferably of at least 70%, more preferably of at least 80%, most preferably of at least 90%, wherein the further colour layer region is characterized by an area coverage in the range from more than 0 up to 15%, preferably from more than 0 up to 13%, more preferably from more than 0 up to 11%, more preferably from more than 0 up to 9%, most preferably from more than 0 up to 5%, wherein the first colour layer region adjoins the further colour layer region. It is preferable that the abovementioned area coverages refer to the same colour.

An inventive embodiment 16 of the process is designed according to any of the preceding embodiments, wherein the external surface is a surface of the carrier layer.

An inventive embodiment 17 of the process is designed according to any of the preceding embodiments, wherein the polymeric internal layer includes from 10 to 90% by weight, based on the total weight of the polymeric internal layer, of a polymer produced by means of a metallocene catalyst. A preferred polymer polymerized by means of a metallocene catalyst is an mPE.

An inventive embodiment 18 of the process is designed according to any of the preceding embodiments, wherein the polymeric internal layer includes a polymer blend, wherein the polymer blend includes from 10 to 90% by weight of an mPE and at least 10% by weight of a further polymer, based in each case on the total weight of the polymer blend.

An inventive embodiment 19 of the process is designed according to any of the preceding embodiments, wherein the carrier layer includes, preferably consists of, one selected from the group consisting of paperboard, cardboard, and paper, or a combination of at least two thereof.

An inventive embodiment 20 of the process is designed according to any of the preceding embodiments, wherein the carrier layer has at least one hole, wherein the hole has been covered at least by the barrier layer and at least by the polymeric internal layer as hole-covering layers. The hole-covering layers are in each case the layers covering the at least one hole.

An inventive embodiment 21 of the process is designed according to any of the preceding embodiments, wherein the external surface is not included by a covering layer of the carrier layer. A preferred covering layer is a “paper-coating layer”.

An embodiment 1 of a printed sheetlike composite 1 obtainable via the process according to any of the embodiments 1 to 21 makes a contribution to achievement of at least one of the objects of the invention.

An inventive embodiment 2 of the printed sheetlike composite 1 is designed according to the embodiment 1, wherein the external surface of the sheetlike composite has been joined to a colour layer, wherein the colour layer is characterized by a number of absent matrix dots in the range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm². It is preferable that the external surface has been printed with the colour layer.

An inventive embodiment 3 of the printed sheetlike composite 1 is designed according to the preceding embodiment, wherein the colour layer includes a first colour layer region and a further colour layer region, wherein the first colour layer region is characterized by an area coverage of at least 50%, preferably of at least 60%, more preferably of at least 70%, more preferably of at least 80%, most preferably of at least 90%, wherein the further colour layer region is characterized by an area coverage in the range from more than 0 up to 15%, preferably from more than 0 up to 13%, more preferably from more than 0 up to 11%, more preferably from more than 0 up to 9%, most preferably from more than 0 up to 5%, wherein the first colour layer region adjoins the further colour layer region. It is preferable that the abovementioned area coverages refer to the same colour.

An embodiment 1 of device including, as device constituents,
a) a sheetlike composite including, as mutually superposed layers, from an external surface of the sheetlike composite to an internal surface of the sheetlike composite,
   i) a carrier layer,
   ii) a barrier layer, and
   iii) a polymeric internal layer;
b) an electrode arranged and designed for the transfer of electrical charge carriers onto the external surface of the sheetlike composite; and
c) a first component including a first component surface,
   wherein the first component surface includes a plurality of recesses, wherein the recesses include a composition including a colourant, wherein the first component surface has been brought into contact with the external surface of the sheet composite
      makes a contribution to achievement of at least one of the objects of the invention.

An inventive embodiment 2 of the device is designed according to the preceding embodiment, wherein the device includes a further electrode downstream of the first component, wherein the further electrode is arranged and designed for acceptance of electrical charge carriers from the external surface of the sheetlike composite.

An inventive embodiment 3 of the device is designed according to the embodiment 1 or 2, wherein the barrier layer is electrically insulating.

An inventive embodiment 4 of the device is designed according to the embodiment 1 or 2, wherein the barrier layer is electrically conductive.

An inventive embodiment 5 of the device is designed according to the embodiment 4, wherein the barrier layer includes a metal or a metal oxide or both, or preferably consists thereof. A preferred metal is aluminium.

An inventive embodiment 6 of the device is designed according to any of the embodiments 1 to 5, wherein the device includes a further component, wherein the sheetlike composite has been brought into contact with the further component, wherein the first component moves in a first direction, wherein the further component moves in a further direction, wherein the further direction differs from the first direction. It is preferable here that the sheetlike composite has been brought into contact at its internal surface with the further component. It is preferable that the further component guides the sheetlike composite. It is preferable that the first direction is opposite to the further direction.

An inventive embodiment 7 of the device is designed according to the embodiment 6, wherein the first component rotates, wherein the first direction is a first direction of rotation, wherein the further component rotates, wherein the further direction is a further direction of rotation.

An inventive embodiment 8 of the device is designed according to the embodiment 7, wherein the first rotating component is an intaglio printing roll.

An inventive embodiment 9 of the device is designed according to any of the embodiments 1 to 8, wherein the first component has been earthed.

An inventive embodiment 10 of the device is designed according to any of the embodiments 1 to 9, wherein the sheetlike composite is characterized by an ignition residue in the range from 0.1 to 75 mg, preferably from 0.2 to 50 mg, most preferably from 0.3 to 30 mg.

An inventive embodiment 11 of the device is designed according to any of the embodiments 1 to 10, wherein the sheetlike composite further includes a polymeric external layer on one side of the carrier layer, wherein the said side faces towards the external surface, wherein the thickness of the polymeric external layer is in the range from 1 to 30 μm, preferably from 2 to 25 μm, more preferably from 3 to 20 μm.

An inventive embodiment 12 of the device is designed according to any of the embodiments 1 to 10, wherein the external surface is a surface of the carrier layer.

An inventive embodiment 13 of the device is designed according to any of the embodiments 1 to 12, wherein the polymeric internal layer includes from 10 to 90% by weight, based on the total weight of the polymeric internal layer, of a polymer produced by means of a metallocene catalyst. A preferred polymer polymerized by means of a metallocene catalyst is an mPE.

An inventive embodiment 14 of the device is designed according to any of the embodiments 1 to 13, wherein the polymeric internal layer includes a polymer blend, wherein the polymer blend includes from 10 to 90% by weight of an mPE and at least 10% by weight of a further polymer, based in each case on the total weight of the polymer blend.

An inventive embodiment 15 of the device is designed according to any of the embodiments 1 to 14, wherein the carrier layer includes, preferably consists of, one selected from the group consisting of paperboard, cardboard, and paper, or a combination of at least two thereof.

An inventive embodiment 16 of the device is designed according to any of the embodiments 1 to 15, wherein the carrier layer has at least one hole, wherein the hole has been covered at least by the barrier layer and at least by the polymeric internal layer as hole-covering layers. The hole-covering layers are in each case the layers covering the at least one hole.

An inventive embodiment 17 of the device is designed according to any of the embodiments 1 to 16, wherein the external surface is not included by a covering layer of the carrier layer.

An embodiment 1 of a printed sheetlike composite 2 including, as mutually superposed layers, from an external surface of the printed sheetlike composite to an internal surface of the printed sheetlike composite,
i) a colour layer,
ii) a carrier layer,
iii) a barrier layer, and
iv) a polymeric internal layer,
   wherein the printed sheetlike composite is characterized by an ignition residue in the range from 0.1 to 75 mg, preferably from 0.2 to 50 mg, most preferably from 0.3 to 30 mg makes a contribution to achievement of at least one of the objects of the invention.

An inventive embodiment 2 of the printed sheetlike composite 2 is designed according to the embodiment 1, wherein the sheetlike composite further includes a polymeric external layer between the colour layer and the carrier layer, wherein the polymeric external layer is characterized by a layer thickness in the range from 1 to 30 μm, preferably from 2 to 25 μm, more preferably from 3 to 20 μm.

An embodiment 1 of a printed sheetlike composite 3 including, as mutually superposed layers, from an external surface of the printed sheetlike composite to an internal surface of the printed sheetlike composite,
i) a colour layer,
ii) a polymeric external layer,
iii) a carrier layer,
iv) a barrier layer, and
v) a polymeric internal layer,
   wherein the polymeric external layer is characterized by a layer thickness in the range from 1 to 30 μm, preferably from 2 to 25 μm, more preferably from 3 to 20 μm, makes a contribution to achievement of at least one of the objects of the invention.

An inventive embodiment 2 of the printed sheetlike composite 3 is designed according to the embodiment 1, wherein the printed sheetlike composite is characterized by an ignition residue in the range from 0.1 to 75 mg, preferably from 0.2 to 50 mg, most preferably from 0.3 to 30 mg.

An inventive embodiment 3 of the printed sheetlike composite 2 or 3 is designed according to the respective embodiment 1 or 2, wherein the colour layer includes a first colour layer region and a further colour layer region, wherein the first colour layer region is characterized by an area coverage of at least 50%, preferably of at least 60%, more preferably of at least 70%, more preferably of at least 80%, most preferably of at least 90%, wherein the further colour layer region is characterized by an area coverage in the range from more than 0 up to 15%, preferably from more than 0 up to 13%, more preferably from more than 0 up to 11%, more preferably from more than 0 up to 9%, most preferably from more than 0 up to 5%, wherein the first colour layer region adjoins the further colour layer region. It is preferable that the abovementioned area coverages refer to the same colour.

An inventive embodiment 4 of the printed sheetlike composite 2 or 3 is designed according to any of the respective embodiments 1 to 3, wherein the colour layer is characterized by a number of absent matrix dots in the range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

An embodiment 1 of a container precursor at least to some extent including the printed sheetlike composite 1 according to any of the embodiments 1 to 3, or the printed sheetlike composite 2 or 3 according to any of the respective embodiments 1 to 4 makes a contribution to achievement of at least one of the objects of the invention.

An embodiment 1 of a closed container at least to some extent including the printed sheetlike composite 1 according to any of the embodiments 1 to 3, or the printed sheetlike composite 2 or 3 according to any of the respective embodiments 1 to 4, wherein the printed sheetlike composite has been folded at least once, more preferably at least twice, more preferably at least 3 times, more preferably at least 4 times, more preferably at least 5 times, most preferably at least 8 times makes a contribution to achievement of at least one of the objects of the invention.

An embodiment 1 of a use of the device according to any of the embodiments 1 to 17 for printing of the sheetlike composite makes a contribution to achievement of at least one of the objects of the invention. A preferred printing is an intaglio printing.

In an inventive embodiment 2 of the use of the device, the printing takes place directly onto a surface of the carrier layer.

Preferred embodiments of constituents of a category of the invention, in particular of the process, of the printed sheetlike composite, of the container precursor, of the closed container, of the device and of the use are likewise preferred for the eponymous or corresponding constituents of the respective other categories of the invention.

### External Surface

The external surface of the sheetlike composite is the surface which in a container to be produced from the sheetlike composite faces predominantly outwards. Accordingly, the external surface is in direct contact with an environment of the container. The external surface and the internal surface in the sheetlike composite form surfaces opposite to one another in the sheetlike composite.

### Layers

Unless otherwise stated, the layers in a layer sequence can follow one another indirectly, i.e. with one or at least two intermediate layers, or directly, i.e. without intermediate layer. This is in particular the case with wording wherein there is a layer superposed on another layer. Wording wherein a layer sequence includes a list of layers means that at least the stated layers are present in the stated sequence. This wording does not necessarily mean that these layers follow one another directly. Wording wherein two layers are adjacent to one another means that these two layers follow one another directly, and therefore without intermediate layer.

### Carrier Layer

Material used as carrier layer can be any suitable material which is known to the person skilled in the art for this purpose and which has strength and stiffness sufficient to provide the container with stability to such an extent that the container in essence retains its shape in the presence of its contents. This document also uses the term dimensionally stable to describe a container of this type. In particular, bags and containers made of foils without carrier layer are not dimensionally stable. Preferred materials for the carrier layer are not only several plastics but also plant-based fibre materials, in particular chemical pulps, preferably glued, bleached and/or unbleached chemical pulps, particular preference being given here to paper and paperboard. The weight per unit area of the carrier layer is preferably in the range from 120 to 450 g/m², particularly preferably in the range from 130 to 400 g/m² and most preferably in the range from 150 to 380 g/m². A preferred paperboard generally has a single- or multilayer structure and can have been coated on one or both sides with one or more covering layers. The residual moisture content of a preferred paperboard is moreover less than 20% by weight, preferably from 2 to 15% by weight and particularly preferably from 4 to 10% by weight, based on the total weight of the paperboard. A particularly preferred paperboard has a multilayer structure. It is further preferable that the paperboard has, on the surface facing towards the environment, at least one, but particularly preferably at least two, sublayers of a covering layer known to the person skilled in the art as “paper coating”. The Scott Bond value of a preferred paperboard is moreover in the range from 100 to 360 J/m², preferably from 120 to 350 J/m² and particularly preferably from 135 to 310 J/m². Use of the abovementioned ranges allows provision of a composite from which it is easily possible to fold a highly leakproof container with narrow tolerances. A preferred carrier layer includes on at least one surface, preferably on each of two mutually opposite surfaces, a covering layer. Except where this is expressly excluded, it is preferable that each carrier layer includes a covering layer on each surface. It is preferable that the carrier layer is of one-piece design.

### Barrier Layer

Material used as barrier layer can be any material which is known for this purpose to the person skilled in the art and which exhibits adequate barrier action in particular in relation to oxygen. It is preferable that the barrier layer is selected from
a. a plastics barrier layer;
b. a metal layer;
c. a metal oxide layer; or
d. a combination of at least two of a. to c.

It is preferable that the barrier layer is of one-piece design.

If, according to alternative a., a barrier layer is a plastics barrier layer, this preferably includes at least 70% by weight, particularly at least 80% by weight and most preferably at least 95% by weight, of at least one plastic which is known for this purpose to the person skilled in the art, in particular on account of aroma properties or, respectively, gas-barrier properties that are suitable for packaging containers. Plastics, in particular thermoplastics, that can be used here are N- or O-containing plastics, either as such or else in mixtures of two or more. A melting point of the plastics barrier layer in the range from more than 155 to 300° C., preferably in the range from 160 to 280° C. and particularly preferably in the range from 170 to 270° C. can prove advantageous according to the invention. A preferred electrically insulating barrier layer is a plastics barrier layer.

It is further preferable that the weight per unit area of the plastics barrier layer is in the range from 2 to 120 g/m², preferably in the range from 3 to 60 g/m², particularly preferably in the range from 4 to 40 g/m² and with further preference from 6 to 30 g/m². It is further preferable that the plastics barrier layer can be obtained from melts, for example via extrusion, in particular layer extrusion. It is further preferable that the plastics barrier layer can be introduced into the sheetlike composite by way of lamination. Preference is given here to incorporation of a foil into the sheetlike composite. According to another embodiment it is also possible to select plastics barrier layers which can be obtained via deposition from a solution or dispersion of plastics.

Suitable polymers are preferably those whose weight-average molar mass, determined by gel permeation chromatography (GPC) using light scattering, is in the range from 3·10³ to 1·10⁷ g/mol, preferably in the range from 5·10³ to 1·10⁶ g/mol and particularly preferably in the range from 6·10³ to 1·10⁵ g/mol. Suitable polymers that in particular can be used are polyamide (PA) or polyethylene vinyl alcohol (EVOH) or a mixture thereof.

Among the polyamides, it is possible to use any of the PAs that appear to a person skilled in the art to be suitable for the inventive use. Particular mention should be made here of PA 6, PA 6.6, PA 6.10, PA 6.12, PA 11 or PA 12 or a mixture of at least two thereof, particular preference being given here to PA 6 and PA 6.6, and further preference being given here to PA 6. PA 6 is obtainable commercially by way of example with the trademark Akulon®, Durethan® and Ultramid®. Other suitable materials are amorphous polyamides such as MXD6, Grivory®, and also Selar® PA. It is further preferable that the density of the PA is in the range from 1.01 to 1.40 g/cm³, preferably in the range from 1.05 to 1.30 g/cm³ and particularly preferably in the range from 1.08 to 1.25 g/cm³. It is further preferable that the viscosity number of the PA is in the range from 130 to 185 ml/g and preferably in the range from 140 to 180 ml/g.

EVOH that can be used is any of the EVOHs that appear to the person skilled in the art to be suitable for the inventive use. Examples here are obtainable commercially inter alia with the trademark EVAL™ from EVAL Europe NV, Belgium in a plurality of different embodiments, examples being the grades EVAL™ F104B and EVAL™ LR171B. Preferred EVOHs have at least one, two, a plurality of, or all of, the following properties:
ethylene content in a range from 20 to 60 mol %, preferably from 25 to 45 mol %;
density in the range from 1.0 to 1.4 g/cm³, preferably from 1.1 to 1.3 g/cm³;
melting point in the range from above 155 to 235° C., preferably from 165 to 225° C.;
MFR (210° C./2.16 kg if T_{M(EVOH)}<230° C.; 230° C./2.16 kg, if 210° C.<T_{M(EVOH)}<230° C.) in the range from 1 to 25 g/10 min, preferably from 2 to 20 g/10 min;
oxygen permeation rate in the range from 0.05 to 3.2 cm³·20 μm/m²·day·atm, preferably in the range from 0.1 to 1 cm³·20 μm/m²·day·atm.

According to alternative b. the barrier layer is a metal layer. A suitable metal layer is in principle any of the layers using metals which are known to the person skilled in the art and which can provide high impermeability to light and to oxygen. According to a preferred embodiment the metal layer can take the form of a film or of a deposited layer, e.g. after a physical gas-phase deposition process. It is preferable that the metal layer is an uninterrupted layer. According to another preferred embodiment, the thickness of the metal layer is in the range from 3 to 20 μm, preferably in the range from 3.5 to 12 μm and particularly preferably in the range from 4 to 10 μm.

Metals preferably selected are aluminium, iron or copper. A preferred iron layer can be a steel layer, e.g. in the form of a foil. It is further preferable that the metal layer is a layer using aluminium. The aluminium layer can advantageously consist of an aluminium alloy, for example AlFeMn, AlFe1.5Mn, AlFeSi or AlFeSiMn. Purity is usually 97.5% or higher, preferably 98.5% or higher, based in each case on the entire aluminium layer. In a particular embodiment the metal layer consists of an aluminium foil. The extensibility of suitable aluminium foils is more than 1%, preferably more than 1.3% and particularly preferably more than 1.5%, and their tensile strength is more than 30 N/mm², preferably more than 40 N/mm² and particularly preferably more than 50 N/mm². Suitable aluminium foils exhibit a droplet size of more than 3 mm in the pipette test, preferably more than 4 mm and particularly preferably more than 5 mm. Suitable alloys for the production of aluminium layers or aluminium foils are obtainable commercially as EN AW 1200, EN AW 8079 or EN AW 8111 from Hydro Aluminium Deutschland GmbH or Amcor Flexibles Singen GmbH. A preferred electrically conductive barrier layer is a metal barrier layer, particularly preferably an aluminium barrier layer.

When a metal foil is used as barrier layer, there can be an adhesion-promoter layer provided on one or both sides of the metal foil between the metal foil and the closest polymer layer. According to a particular embodiment of the container of the invention, however, there is no adhesion-promoter layer provided on any side of the metal foil between the metal foil and the closest polymer layer.

It is further preferable to select a metal oxide layer as barrier layer according to alternative c. Metal oxide layers that can be used are any of the metal oxide layers that are familiar to the person skilled in the art and that appear suitable for achieving a barrier effect in relation to light, water vapour and/or gas. In particular, preference is given to metal oxide layers based on the abovementioned metals aluminium, iron or copper and also to metal oxide layers based on compounds of titanium or silicon oxide. A metal oxide layer is produced by way of example via deposition of a metal oxide from a vapour onto a plastics layer, for example an oriented polypropylene film. A preferred process for this is physical gas-phase deposition.

According to another preferred embodiment the metal layer or the metal oxide layer can take the form of a layer composite made of one or more plastics layers with a metal layer. This type of layer can be obtained by way of example via vapour deposition of a metal onto a plastics layer, for example an oriented polypropylene film. A preferred process for this is physical gas-phase deposition.

### Polymer Layers

It is preferable that there is a polymer layer located between the carrier layer and the barrier layer. Each polymer layer can comprise further constituents. It is preferable that these polymer layers are introduced or, respectively, applied into the layer sequence in an extrusion process. The further constituents of the polymer layers are preferably constituents which do not adversely affect the behaviour of the polymer melt when applied as layer. The further constituents can by way of example be inorganic compounds, such as metal salts or further plastics, for example further thermoplastics. However, it is also conceivable that the further constituents are fillers or pigments, for example carbon black or metal oxides. Suitable thermoplastics that can be used for the further constituents are in particular those that are easily processable by virtue of good extrusion properties. Materials suitable in this context are polymers obtained via chain polymerization, in particular polyesters or polyolefins, particular preference being given here to cyclic olefin copolymers (COC), and polycyclic olefin copolymers (POC), and in particular polyethylene and polypropylene, and very particular preference being given here to polyethylene. Among the polyethylenes, preference is given to HDPE, MDPE, LDPE, LLDPE, VLDPE and PE, and also to mixtures of at least two thereof. It is also possible to use mixtures of at least two thermoplastics. The melt flow rate (MFR) of suitable polymer layers is in the range from 1 to 25 g/10 min, preferably in the range from 2 to 20 g/10 min and particularly preferably in the range from 2.5 to 15 g/10 min, their density being in the range from 0.890 g/cm³ to 0.980 g/cm³, preferably in the range from 0.895 g/cm³ to 0.975 g/cm³, and more preferably in the range from 0.900 g/cm³ to 0.970 g/cm³. The polymer layers preferably have at least one melting point in the range from 80 to 155° C., with preference in the range from 90 to 145° C. and particularly preferably in the range from 95 to 135° C. A preferred polymer layer is a polyolefin layer, preferably a polyethylene layer or a polypropylene layer or both.

### Polyolefin

A preferred polyolefin is a polyethylene (PE) or a polypropylene or both. A preferred polyethylene is one selected from the group consisting of an LDPE, an LLDPE, and an HDPE, or a combination of at least two thereof. A particularly preferred PE is an LDPE. Another preferred polyolefin is an m-polyolefin. The melt flow rate (MFR) of suitable polyethylenes is in the range from 1 to 25 g/10 min, preferably in the range from 2 to 20 g/10 min and particularly preferably in the range from 2.5 to 15 g/10 min, their density being in the range from 0.910 g/cm³ to 0.935 g/cm³, preferably in the range from 0.912 g/cm³ to 0.932 g/cm³, and more preferably in the range from 0.915 g/cm³ to 0.930 g/cm³.

m-Polyolefin

An m-polyolefin is a polyolefin produced by means of a metallocene catalyst. A metallocene is an organometallic compound in which there is a central metal atom arranged between two organic ligands, for example cyclopentadienyl ligands. A preferred m-polyolefin is an m-polyethylene (mPE) or an m-polypropylene or both. A preferred mPE is one selected from the group consisting of an mLDPE, an mLLDPE, and an mHDPE, or a combination of at least two thereof.

### Polymeric Internal Layer

In a preferred embodiment the polymeric internal layer includes from 10 to 50% by weight, preferably 15 to 45% by weight, more preferably from 20 to 40% by weight, most preferably from 25 to 35% by weight, based in each case on the total weight of the polymeric internal layer, of a polymer produced by means of a metallocene catalyst. In another preferred embodiment the polymeric internal layer includes from 20 to 90% by weight, preferably from 30 to 90% by weight, more preferably from 40 to 90% by weight, more preferably from 50 to 90% by weight, more preferably from 60 to 90% by weight, most preferably from 70 to 85% by weight, based in each case on the total weight of the polymeric internal layer, of a polymer produced by means of a metallocene catalyst.

It is preferable that the polymeric internal layer consists of the polymer blend including an mPE and a further polymer. A preferred further polymer is a PE. In a preferred embodiment the polymer blend includes from 10 to 50% by weight, preferably from 15 to 45% by weight, more preferably from 20 to 40% by weight, most preferably from 25 to 35% by weight, of an mPE and at least 50% by weight, preferably at least 55% by weight, more preferably at least 60% by weight, most preferably at least 65% by weight, of a further polymer, based in each case on the total weight of the polymer blend. In another preferred embodiment the polymer blend includes from 20 to 90% by weight, preferably from 30 to 90% by weight, more preferably from 40 to 90% by weight, more preferably from 50 to 90% by weight, more preferably from 60 to 90% by weight, most preferably from 70 to 85% by weight, of an mPE and at least 10% by weight, preferably at least 15% by weight, of a further polymer, based in each case on the total weight of the polymer blend. The proportions of mPE and of further polymer in the polymer blend here are preferably combined in such a way that the sum of the proportions is 100% by weight. In each case the preferred proportions of mPE and of further polymer in the polymer blend are combined in such a way that the sum of the proportions is not more than 100% by weight. It is preferable that the internal surface of the sheetlike composite is a polymeric-internal-layer surface that faces away from the barrier layer. The internal surface of the sheetlike composite here is the surface which in a container to be produced from the sheetlike composite faces predominantly inwards, i.e. in particular is in direct contact with a food contained in the container.

### Melting Points

A preferred m-polyolefin is characterized by at least one first melting point and one second melting point. It is preferable that the m-polyolefin is characterized by a third melting point in addition to the first and the second melting point. A preferred first melting point is in the range from 84 to 108° C., preferably from 89 to 103° C., more preferably from 94 to 98° C. A preferred further melting point is in the range from 100 to 124° C., preferably from 105 to 119° C., more preferably from 110 to 114° C.

### Adhesion/Adhesion-Promoter Layer

There can be an adhesion-promoter layer located between layers of the sheetlike composite which are not immediately adjacent to one another. In particular, there can be an adhesion-promoter layer located between the barrier layer and the polymeric internal layer or the carrier layer and the barrier layer.

Plastics which can be used as adhesion promoters in an adhesion-promoter layer are any of those which, by virtue of functionalization by means of suitable functional groups, are suitable to produce a secure bond via formation of ionic bonds or covalent bonds to a surface of a respective adjacent layer. The materials are preferably functionalized polyolefins obtained via copolymerization of ethylene with acrylic acids such as acrylic acid or methacrylic acid, crotonic acid, acrylates, acrylate derivatives or carboxylic anhydrides containing double bonds, for example maleic anhydride, or at least two thereof. Among these, preference is given to polyethylene-maleic anhydride graft polymers (EMAH), ethylene-acrylic acid copolymers (EAA) or ethylene-methacrylic acid copolymers (EMAA), which are marketed by way of example with the trademarks Bynel® and Nucrel®0609HSA by DuPont or Escor®6000ExCo by ExxonMobil Chemicals.

According to the invention it is preferable that the adhesion between a carrier layer, a polymer layer or a barrier layer and the respective closest layer is at least 0.5 N/15 mm, preferably at least 0.7 N/15 mm and particularly preferably at least 0.8 N/15 mm. In an embodiment of the invention it is preferable that the adhesion between a polymer layer and a carrier layer is at least 0.3 N/15 mm, preferably at least 0.5 N/15 mm and particularly preferably at least 0.7 N/15 mm. It is further preferable that the adhesion between a barrier layer and a polymer layer is at least 0.8 N/15 mm, preferably at least 1.0 N/15 mm and particularly preferably at least 1.4 N/15 mm. In the event that a barrier layer follows a polymer layer indirectly by way of an adhesion-promoter layer it is preferable that the adhesion between the barrier layer and the adhesion-promoter layer is at least 1.8 N/15 mm, preferably at least 2.2 N/15 mm and particularly preferably at least 2.8 N/15 mm. In a particular embodiment the adhesion between the individual layers is so strong that the adhesion test leads to tearing of a carrier layer, the term used in the event of paperboard as carrier layer being paperboard fibre tear.

### Components

The first component is designed to receive printing ink into the recesses, also termed cells, and for the transfer of at least a portion of the printing ink from the recesses to the external surface of the sheetlike composite. To this end, it is preferable that the external surface is pressed onto the first component surface. A preferred first component is a printing plate or a printing roll or both. A preferred printing plate is an intaglio printing plate. A preferred printing roll is an intaglio printing roll. A preferred first component surface is flat or takes the form of the curved surface of a cylinder, or both. A preferred further component is a further roll. A preferred further roll is a counterpressure roll. A preferred counterpressure roll is an impression roll. It is preferable that the impression roll consists of a hard material such as wood or metal covered by a rubber layer.

### Composition

A preferred composition is a solution or a suspension or both. Another preferred composition is a printing ink. A preferred printing ink is a printing ink for intaglio printing. A preferred colourant is a pigment. It is preferable that the composition in the recesses in each case includes a convex surface.

### Contacting/Printing

A preferred contacting is an applying of pressure. It is preferable that the contacting is a printing. In this, the sheetlike composite is preferably passed through a gap between the intaglio printing roll and the impression roll.

### Covering Layer

A preferred covering layer is a “paper-coating layer”. In papermaking a “paper-coating layer” is an covering layer which includes inorganic solid particles, preferably pigments and additives. It is preferable that the “paper-coating layer” is applied in the form of liquid phase, preferably in the form of suspension or dispersion, to a surface of a paper- or paperboard-containing layer. A preferred dispersion is an aqueous dispersion. A preferred suspension is an aqueous suspension. Another preferred liquid phase includes inorganic solid particles, preferably pigments; a binder; and additives. A preferred pigment is selected from the group consisting of calcium carbonate, kaolin, talcum, silicate, a plastics pigment and titanium dioxide. A preferred kaolin is a calcined kaolin. A preferred calcium carbonate is one selected from the group consisting of marble, chalk and a precipitated calcium carbonate (PCC) or a combination of at least two thereof. A preferred silicate is a phyllosilicate. A preferred plastics pigment is spherical, preferably hollow-spherical. A preferred binder is one selected from the group consisting of styrene-butadiene, acrylate, acrylonitrile, a starch and a polyvinyl alcohol or a combination of at least two thereof, preference being given here to acrylate. A preferred starch is one selected from the group consisting of cationically modified, anionically modified and fragmented or a combination of at least two thereof. A preferred additive is one selected from the group consisting of a rheology modifier, a shading dye, an optical brightener, a carrier for an optical brightener, a flocculating agent, a deaerating agent and a surface-energy modifier or a combination of at least two thereof. A preferred deaerating agent is a deaerating agent which is used for coloured coating slips and which is preferably based on silicone or on fatty acid or on both. A preferred surface-energy modifier is a surfactant.

### Container Precursor

A container precursor is a closed-container precursor produced during the production of a closed container. The container precursor here includes the sheetlike composite in cut-to-size form. The sheetlike composite here can be unfolded or folded. A preferred container precursor has been cut to size and is designed for the production of a single closed container. Another term used for a preferred container precursor which has been cut to size and is designed for the production of a single closed container is also referred to a jacket or a sleeve. The jacket or sleeve here includes the folded sheetlike composite. The jacket or sleeve moreover includes a longitudinal seam and is open in a top region and in a base region. The term tube is often used for a typical container precursor which has been cut to size and is designed for the production of a plurality of closed containers.

Another preferred container precursor is open, preferably in a top region or in a top region, particularly preferably in both. A preferred container precursor takes the form of a jacket or of a tube or both. Another preferred container precursor includes the printed sheetlike composite in a manner such that the printed sheetlike composite has been folded at least once, preferably at least twice, more preferably at least 3 times, most preferably at least 4 times. A preferred container precursor is of a one-piece design. It is particularly preferable that a base region of the container precursor is of a one-piece design with a lateral region of the container precursor.

### Container

The closed container of the invention can have a plurality of different shapes, but preference is given to a structure that is in essence a rectangular parallelepiped. It is moreover possible that the entire area of the container is composed of a sheetlike composite, or that the container has a two- or multipart structure. In the case of a multipart structure it is conceivable that other materials are also used alongside the sheetlike composite, an example being plastic, which in particular can be used in the top or base regions of the container. However, it is preferable here that at least 50%, particularly at least 70% and more preferably at least 90%, of the area of the container is composed of the sheetlike composite. The container can moreover comprise a device for the discharge of the contents. This can by way of example be formed from plastic and applied to the external side of the container. It is also conceivable that this device has been integrated into the container via “direct injection moulding”. According to a preferred embodiment the container of the invention has at least one folded edge, preferably from 4 to 22, or even more folded edges, particularly preferably from 7 to 12 folded edges. For the purposes of the present invention the expression folded edge applies to regions produced when an area is folded. Examples of folded edges that may be mentioned are the longitudinal regions where two respective wall areas of the container meet. The container walls in the container are preferably the areas of the container, surrounded by the folded edges. It is preferable that the closed container includes no base that is not of single-piece design with the sheetlike composite or no lid that is not of single-piece design with the sheetlike composite, or both.

### Food

A preferred closed container of the invention includes a food. Materials that can be regarded as foods are any of the solid or liquid foods known to the person skilled in the art for human consumption, and also those for consumption by animals. Preferred foods are liquid above 5° C., examples being dairy products, soups, sauces, and non-carbonated drinks There are various methods for filling the container or the container precursor. A first possibility is that the food and the container or the container precursor are separately, before the filling process, sterilized to the greatest possible extent via suitable measures such as treatment of the container or of the container precursor with H₂O₂, UV radiation or other suitable high-energy radiation, plasma or a combination of at least two thereof, and also heating of the food, and that the container or the container precursor is then filled. This filling method is often termed “aseptic filling”, and is preferred according to the invention. In another method that is widely used, in addition to or else instead of aseptic filling, the container or container precursor filled with food is heated to reduce the number of germs. This is preferably achieved via pasteurization or autoclaving. In this procedure it is also possible to use less sterile foods and containers or container precursors.

### Hole/Opening Aid

In order to provide easier opening of the closed container of the invention, a carrier layer can comprise at least one hole. In a particular embodiment the hole has been covered at least by a barrier layer, and preferably a polymer layer, as hole-covering layers. There can moreover be one or more further layers, in particular adhesion-promoter layers, provided between the abovementioned layers. It is preferable here that the hole-covering layers have been joined to one another at least to some extent, preferably at least 30%, with preference at least 70% and with particular preference at least 90% of the area formed by the hole. According to a particular embodiment it is preferable that the hole penetrates through the entire sheetlike composite and is covered by a closure or opening device that seals the hole. In connection with a preferred embodiment the hole provided in the carrier layer can have any shape that is known to the person skilled in the art and is suitable for various closures, drinking straws or opening aids. Opening of a closed container is mostly achieved by destroying, at least to some extent, the hole-covering layers covering the hole. This destruction can be achieved via cutting, pressing into the container or pulling out of the container. The destruction can be achieved via an openable closure joined to the container and arranged in the region of the hole, mostly above the hole, or via a drinking straw which is forced through the hole-covering layers covering the hole.

According to another preferred embodiment a carrier layer of the sheetlike composite has a plurality of holes in the form of a perforation, where the individual holes have been covered at least by a barrier layer, and preferably by a polymer layer, as hole-covering layers. A container produced from this type of composite can then be opened by tearing along the perforation. Holes of these types for perforations are preferably produced by means of a laser. It is particularly preferable to use laser beams when a metal foil or a metallized foil is used as barrier layer. It is moreover possible to introduce the perforation by using mechanical perforation tools, mostly comprising blades.

According to another preferred embodiment the sheetlike composite is subjected to heat treatment, at least in the region of the at least one hole. Where there is a plurality of holes present in the form of a perforation in the carrier layer it is in particular preferable that this heat treatment is also carried out around the periphery of the hole. The heat treatment can be achieved via radiation, via hot gas, via thermal contact with a solid material, via mechanical oscillations, preferably via ultrasound, or via a combination of at least two of these measures. It is particularly preferable that the heat treatment is achieved via irradiation, preferably electromagnetic radiation and particularly preferably electromagnetic induction, or else via hot gas. The respective optimal operating parameters to be selected are known to the person of average skill in the art.

### Test Methods

The following test methods were used for the purposes of the invention. Unless otherwise stated the measurements were made at ambient temperature 25° C., ambient air pressure 100 kPa (0.986 atm) and relative humidity 50%.

### MFR Value

The MFR value is measured in accordance with the standard ISO 1133 (unless otherwise stated at 190° C. with 2.16 kg).

### Density

Density is measured in accordance with the standard ISO 1183-1.

### Melting Point

Melting point is determined according to the DSC method of ISO 11357-1 and -5. The equipment is calibrated in accordance with the manufacturer's instructions with reference to the following measurements:
indium temperature—onset temperature,
enthalpy of fusion of indium,
zinc temperature—onset temperature.

### Viscosity Number of PA

The viscosity number of PA is measured in accordance with the standard ISO 307 in 95% sulphuric acid.

### Oxygen Permeation Rate

Oxygen permeation rate is determined in accordance with the standard ISO 14663-2 Annex C at 20° C. and 65% relative humidity.

### Paperboard Moisture Content

Paperboard moisture content is measured in accordance with the standard ISO 287:2009.

### Adhesion

Adhesion between two adjacent layers is determined by fixing these onto 90° peel test equipment, for example a “German rotating wheel fixture” from Instron, on a rotating roll which rotates at 40 mm/min during the measurement. The samples were cut to size in advance, into strips of width 15 mm. At one side of the sample the sublayers are separated from one another, and the separated end is clamped into a vertically upwards oriented tensile apparatus. The tensile apparatus has attached measurement equipment for determining the tensile force. During the rotation of the roll, the force required to separate the sublayers from one another is measured. This force corresponds to the adhesion between the layers, and is stated in N/15 mm. The separation of the individual layers can be achieved by way of example mechanically, or via a specific pretreatment, for example via softening of the sample for 3 min in 30% acetic acid at 60° C.

### Molecular Weight Distribution

Molecular weight distribution is measured by gel permeation chromatography, using light scattering: ISO 16014-3/-5.

### Absent Matrix Dots

Five regions of the printed container or laminate measuring 10 mm-10 mm are studied under an optical microscope. An unprinted dot of the printed matrix corresponds here to an absent matrix dot. The absent matrix dots are counted for each of the five regions. The arithmetic average (average value) from the five measurements is the “absent matrix dots” value.

### Area Coverage

The area coverage is a measure of the extent of cover in a printed area as perceived by a standard observer. Area coverage can be calculated by the Murray-Davies formula. All of the area coverage values in this document were measured with the aid of a spectrophotometer (SpectroEye™) from X-Rite (CH-8105 Regensdorf).

### Electrical Charge

The measurement is made in transverse direction in the middle of the web of composite material at intervals of 1 cm, using a Fluke 280 combined with a Fluke 80 k-6 high-voltage probe from Fluke Deutschland GmbH, Glottertal, Germany. The measurement is moreover made on the external surface of the laminate in the middle between the electrode which applies the electrical charges to the sheetlike composite and the first component which prints the sheetlike composite. The first component here is earthed.

### Ignition Residue

In accordance with the standard DIN EN ISO 186 (differing from DIN EN 20 287), for determination of ignition loss sample sections measuring 50 mm-50 mm (0.0025 m²) are produced from the packaging containers or packaging container precursors or laminates to be tested.

The following steps are then carried out:
1. The paperboard sublayers are pulled apart and thus separated. The outer paperboard sublayer with the paper-coating layer and any exterior polymer layer present are separated here from the middle sublayer. The middle sublayer, which includes the interior polymer layer, is discarded.
2. Any exterior polymer layer present and the outer sublayer of the paperboard inclusive of the paper-coating layer are then ignited in accordance with DIN 54370 using ignition method A at 575° C. for about 3 hours.
3. The ignition residue is weighed. The absolute value is stated in milligrams (mg).

### Layer Thickness of the Polymeric External Layer/Colour Layer

A sample measuring about 2.5 to 3.0 cm·1.0 to 1.5 cm is taken from the composite material (laminate, sheetlike composite) to be studied. The longitudinal side of the sample here is perpendicular to the direction of running of the extrusion process and to the fibre direction of the paperboard. The sample is secured in a metal clamp which forms a smooth surface. The sample should not project by more than 2-3 mm. The metal clamp is secured before the cut is made. In order that the cut obtained, in particular of the paperboard fibre, is clean, the sample portion protruding from the metal clamp is iced with cold spray. This is then removed by means of a disposable blade. The pressure exerted by the metal clamp on the sample is then reduced so that the sample can be moved out of the metal clamp by about 3-4 mm. It is then again secured. For study under the optical microscope, the sample in the sample holder is placed on the object stage of the optical microscope under one of the objectives. The appropriate objective should be selected as a function of the layer thickness of the region to be studied. Precise centring is achieved during study under the microscope. Side illumination (swan necks) is used in most cases. If necessary, the epi-illumination system of the optical microscope is used in addition or instead. Once focusing and illumination of the sample have been optimized, the individual layers of the composite are discernible. An Olympus camera with appropriate image-processing software from Analysis is used for documentation and measurements. The thickness of the polymeric external layer is stated in absolute terms in micrometres (μm).

### Equipment List:

Optical microscope; Nikon Eclipse E800
Objective; ×2.5; ×5; ×10; ×20; ×50 magnification
Illumination: swan necks

### Camera: Olympus DP 71

Software: analySIS
Disposable blades; from Leica (Microtome Blades)
Sample holder: metal clamp
Cold spray

### Allen key

### Vice

Cut-resistant gloves

### Scissors

The invention is described in more detail below via Examples and drawings, wherein the Examples and drawings do not imply any restriction of the invention. The drawings are moreover diagrammatic and not true to scale.

### Production of Composite Material (Laminate)

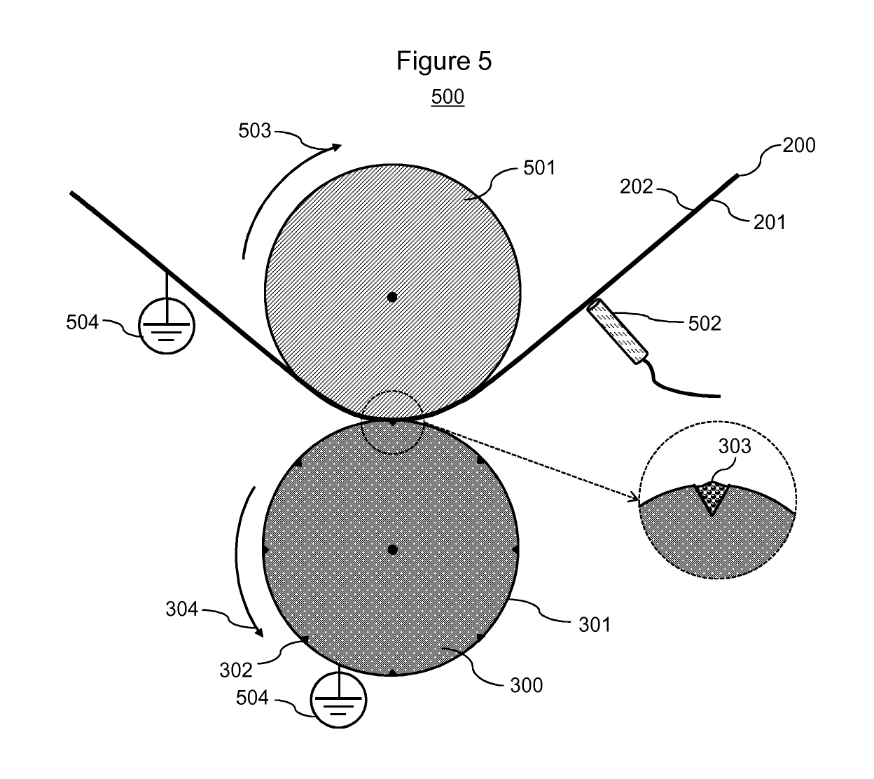

A commercially available uncoated paperboard (NaturaD UC 200 mN; Stora Enso AB; Stockholm, Sweden) is treated in the following steps:
1. The paperboard is first coated in the laboratory with one or more liquid paper-coating layers in accordance with the information below relating to the individual Inventive Examples and Comparative Examples. The formulation of the paper-coating material here is: 100 parts of pigment (Hydrocarb 60; Omya Inc; Cincinnati, US) and 20 parts of binder/SB Latex (MAINCOTE™ HG-56; Dow; Germany).
2. An exterior polymer layer and the interior layers stated below are provided to the coated paperboard by the extrusion coating process.
3. The resultant composite materials are printed by the intaglio printing process either without charging of the laminate by the electrode (Comparative Examples not of the invention) or with charging by way of the electrode (Inventive Examples). The Examples section below states in each case whether, in the latter case, the electrode charges the impression roll directly or, as shown in FIG. 5, charges the laminate directly on its external side.
4. The print quality is analyzed in accordance with the test methods.

### INVENTIVE EXAMPLES AND COMPARATIVE EXAMPLES WITH ELECTRICALLY CONDUCTIVE BARRIER LAYER

Laminates with the following layer structure were used for Inventive Examples 1 to 15 listed below and for Comparative Examples 1 to 7. The said laminates were obtained in the above steps 1. to 4.

colour decor
Polymeric external layer: LDPE Novex ® M19N430 from Ineos Koln
GmbH
Paper-coating layer
Carrier layer: NaturaD UC 200 mN; Stora Enso AB; Stockholm, Sweden
LDPE Novex ® M19N430 from Ineos Koln GmbH
Barrier layer: aluminium EN A W 8079 from Hydro Aluminium
Deutschland GmbH of thickness 6 μm
PE blend including 30% by weight of an mLDPE and 70% by weight of
an LDPE with weight per unit area 22 g/m²

### COMPARATIVE EXAMPLES 1 TO 7 (NOT OF THE INVENTION)

Comparative Examples 1 to 7 are produced without use of an electrode to charge either the impression roll or the laminate in the above step 3. of the production of the laminate.

TABLE 1
Result of printing according to the number of absent matrix dots as a function of the
print matrix used, the area coverage, the layer thickness of the polymeric external
layer and the ignition residue of the laminate, and also the number of paper-coating
layers on the paperboard for the Comparative Examples.

| | | | Thickness | | | |
|---|---|---|---|---|---|---|
| | | | of | | | Number of |
| | | | polymeric | | Number of | absent |
| | Matrix | Area | external | Ignition | paper- | matrix dots |
| Comparative | [dots per | coverage | layer | residue | coating | [per |
| Example | cm] | [%] | [μm] | [mg] | layers | 100 mm²] |
| 1 | 60 | 30 | 16 | 2 | 0 | 136 |
| 2 | 60 | 30 | 16 | 50 | 2 | 9 |
| 3 | 60 | 30 | 16 | 30 | 1 | 28 |
| 4 | 60 | 30 | 11 | 50 | 2 | 51 |
| 5 | 60 | 50 | 15 | 50 | 2 | 11 |
| 6 | 54 | 30 | 16 | 50 | 2 | 7 |
| 7 | 60 | 30 | 11 | 30 | 1 | 45 |

### INVENTIVE EXAMPLES 1 TO 7

Inventive Examples 1 to 7 are produced by using an electrode in step 3. of the production of the laminate to transfer electrical charges to the impression roll and from this to the internal surface of the laminate. No direct charging of laminate on its external surface takes place.

TABLE 2
Result of printing according to the number of absent matrix dots as a
function of the print matrix used, the area coverage, the layer thickness
of the polymeric external layer and the ignition residue of the laminate,
and also the number of paper-coating layers on the paperboard for the
Examples with electrical charging by way of the impression roll

| | | | | | | Number |
|---|---|---|---|---|---|---|
| | | | Thickness | | | of |
| | | | of | | Number | absent |
| | Matrix | Area | polymeric | | of | matrix |
| | [dots | cover- | external | Ignition | paper- | dots |
| Inventive | per | age | layer | residue | coating | [per |
| Example | cm] | [%] | [μm] | [mg] | layers | 100 mm²] |
| 1 | 60 | 30 | 16 | 2 | 0 | 130 |
| 2 | 60 | 30 | 16 | 50 | 2 | 7 |
| 3 | 60 | 30 | 15 | 30 | 1 | 29 |
| 4 | 60 | 30 | 11 | 30 | 1 | 45 |
| 5 | 60 | 30 | 10 | 50 | 2 | 6 |
| 6 | 60 | 50 | 15 | 50 | 2 | 10 |
| 7 | 54 | 30 | 16 | 50 | 2 | 8 |

### INVENTIVE EXAMPLES 8 TO 15

Inventive Examples 8 to 15 are produced by using the electrode in step 3. of the production of the laminate to apply electrical charges to the external surface of the laminate as shown in FIG. 5.

TABLE 3
Result of printing according to the number of absent matrix dots as a function
of the print matrix used, the shade of colour, the layer thickness of the polymeric
external layer and the ignition residue of the laminate, and also the number of
paper-coating layers on the paperboard for the Examples with
direct electrical charging of the external side of the laminate

| | | | Thickness | | | |
|---|---|---|---|---|---|---|
| | | | of | | | |
| | | | polymeric | | Number of | Number of |
| | Matrix [dots | Area | external | Ignition | paper- | absent matrix |
| Inventive | per | coverage | layer | residue | coating | dots [per |
| Example | cm] | [%] | [μm] | [mg] | layers | 100 mm²] |
| 8 | 60 | 30 | 16 | 2 | 0 | 52 |
| 9 | 60 | 30 | 15 | 50 | 2 | 0 |
| 10 | 60 | 30 | 15 | 30 | 1 | 0 |
| 11 | 60 | 30 | 11 | 30 | 1 | 7 |
| 12 | 60 | 30 | 10 | 50 | 2 | 2 |
| 13 | 60 | 50 | 15 | 50 | 2 | 0 |
| 14 | 54 | 30 | 16 | 50 | 2 | 0 |
| 15 | 60 | 30 | 11 | 30 | 1 | 7 |

In the “Matrix” column in each of the Tables 1 to 3 the matrix used for the intaglio printing process is characterized via the number of matrix cells per unit of length in dots per centimetre. The accuracy of the layer thicknesses stated in the Tables 1 to 3 for the polymeric external layers is dependent on the measurement method and in each case is ±1.5 μm.

In the drawings:

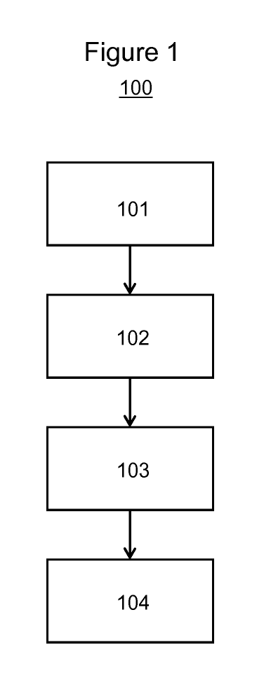

FIG. 1 is a diagram of the sequence of the process of the invention;

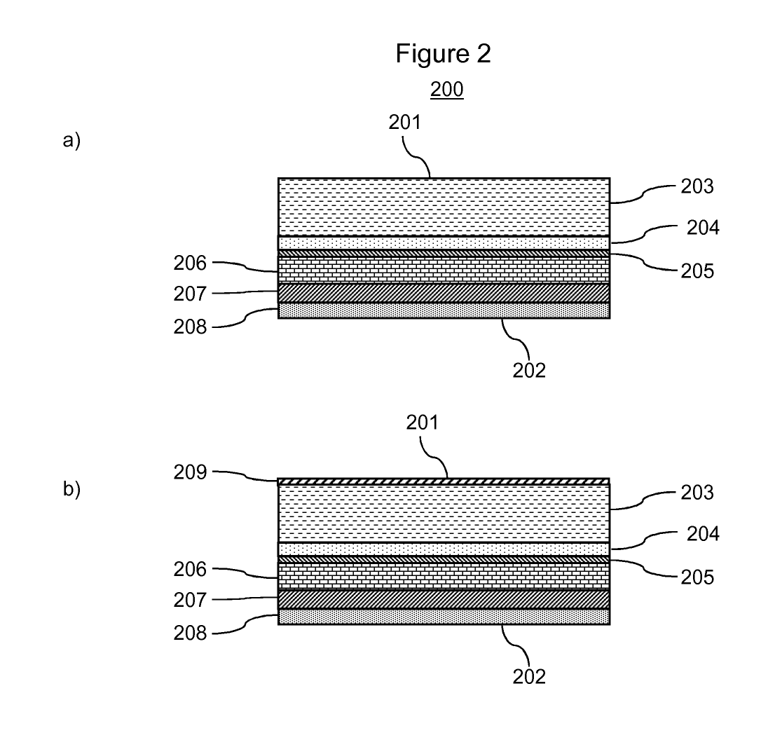

FIG. 2a) is a diagrammatic cross section through a sheetlike composite of the invention;

FIG. 2b) is a diagrammatic cross section through another sheetlike composite of the invention;

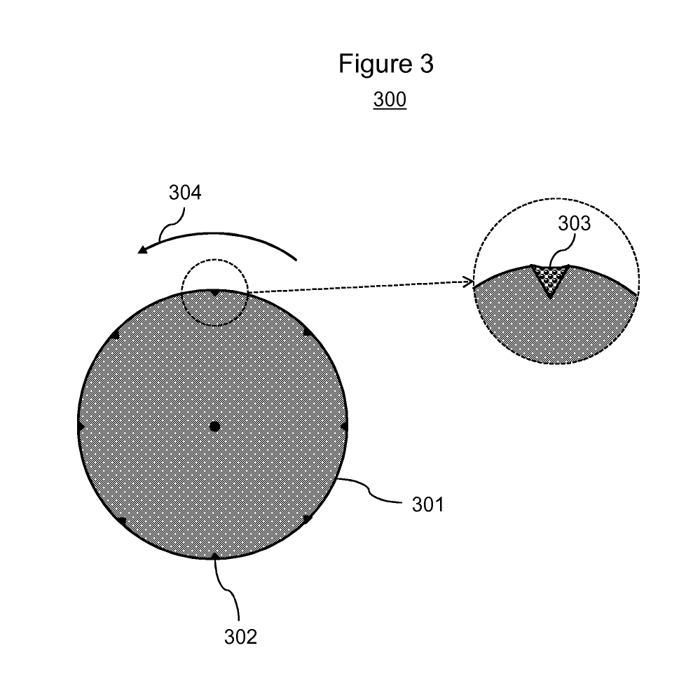

FIG. 3 is a diagrammatic cross section through a first component of the invention;

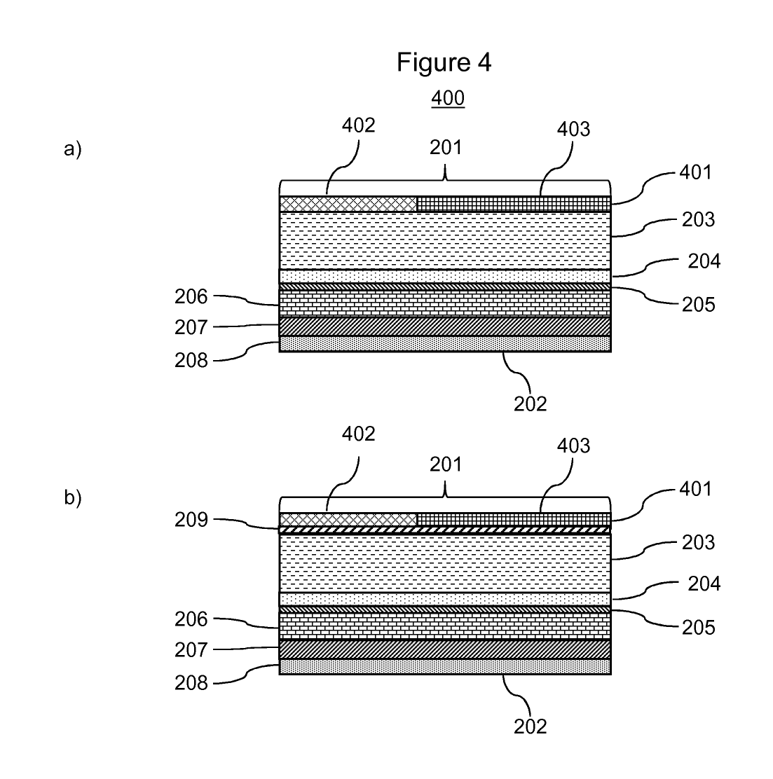

FIG. 4a) is a diagrammatic cross section through a printed sheetlike composite of the invention;

FIG. 4b) is a diagrammatic cross section through another printed sheetlike composite of the invention;

FIG. 5 is a diagrammatic view of a device of the invention;

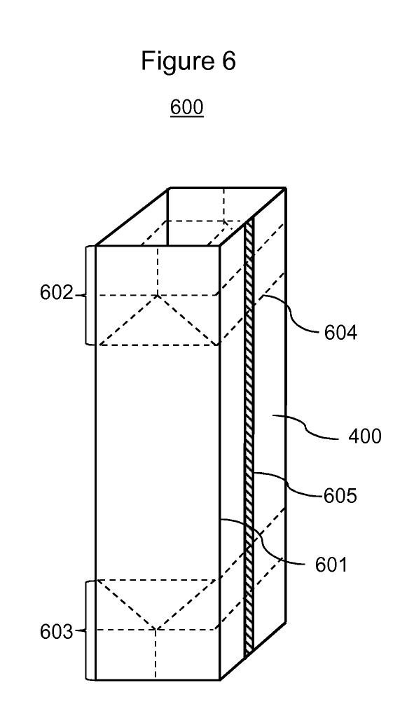

FIG. 6 is a diagrammatic view of a container precursor of the invention;

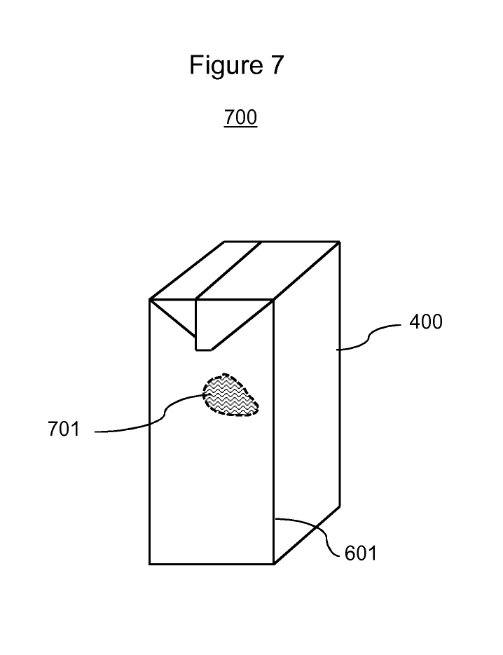

FIG. 7 is a diagrammatic view of a closed container of the invention;

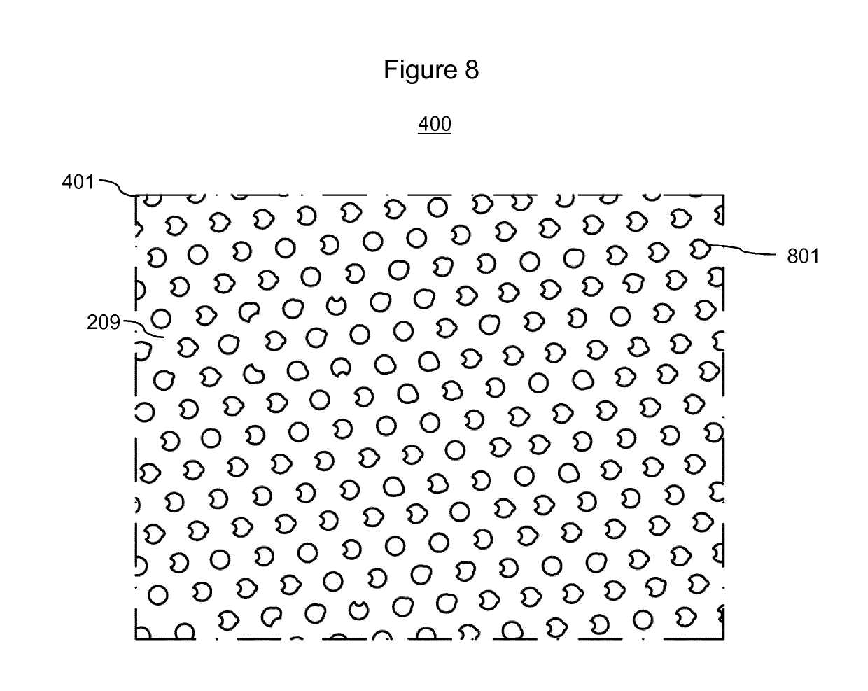

FIG. 8 is a diagrammatic detail of an enlarged plan view of a printed sheetlike composite of the invention; and

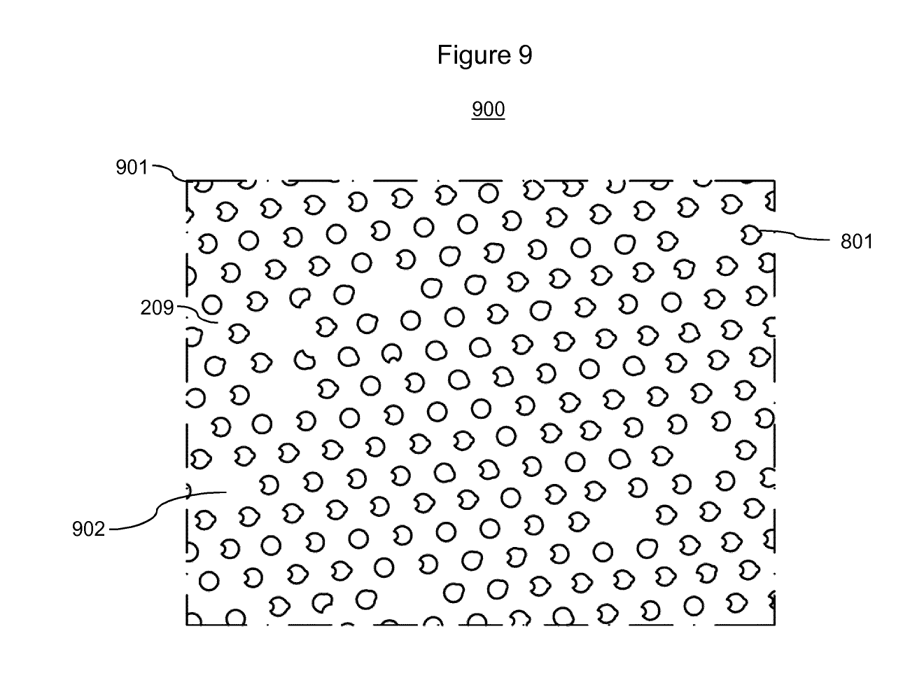

FIG. 9 is a diagrammatic detail of an enlarged plan view of a printed sheetlike composite not of the invention.

FIG. 1 is a diagram of the sequence of the process 100 of the invention. The sheetlike composite 200 according to FIG. 2 is provided in a step a) 101 of the process 100. This sheetlike composite has a first electrical charge. This means that the sheetlike composite in its entirety has an entire charge which is the first electrical charge. In step a) 101 it is preferable that the sheetlike composite is electrically neutral. A first component 300 according to FIG. 3 is provided in a step b) 102 of the process 100 of the invention. The first component 300 moves in a first direction 304. The first component 300 here is an intaglio printing cylinder which rotates in a first direction 304 which is a first direction of rotation. The intaglio printing cylinder has a further electrical charge. It is electrically neutral and earthed. In a step c) 103 the absolute magnitude of the difference between the first electrical charge and the further electrical charge is increased. This occurs via negative electrical charging of the sheetlike composite. To this end, electrons are applied by means of an electrode 502 onto the external surface 201 of the sheetlike composite 200. In a step d) 104 the external surface 201 of the sheetlike composite 200 is brought into contact with the first component surface 301. To this end, the sheetlike composite 200 is forced against the intaglio printing cylinder by means of a further component 501, an impression roll, which is not earthed. The impression roll here rotates in a further direction 503 which is a further direction of rotation. The first direction of rotation is opposite to the further direction of rotation. The process 100 can in particular be implemented by using the device 500 according to FIG. 5.

FIG. 2a) is a diagrammatic cross section through a sheetlike composite 200 of the invention. The sheetlike composite 200 consists of the following layers mutually superposed in this sequence from an external surface 201 of the sheetlike composite 200 to an internal surface 202 of the sheetlike composite 200: a carrier layer 203 made of paperboard, an LDPE layer 204, an adhesion-promoter layer 205, a barrier layer 206 made of aluminium, an EAA layer 207, and a polymeric internal layer 208. The polymeric internal layer 208 here consists of a polymer blend which includes 80% by weight of an mPE and 20% by weight of an LDPE, based in each case on the total weight of the polymer blend. The external surface 201 here is a surface which belongs to the carrier layer 203 and which faces away from the barrier layer 206. The external surface 201 is moreover that surface of the sheetlike composite 200 that faces outwards in a food container produced from the sheetlike composite 200. The internal surface 202 is that surface of the sheetlike composite 200 that faces inwards in a food container produced from the sheetlike composite 200, and accordingly is in contact with the food therein. The sheetlike composite 200 depicted in FIG. 2a) can in particular be printed with a decor according to the process 100 of FIG. 1 or with the aid of the device 500 of FIG. 5, or both.

FIG. 2b) is a diagrammatic cross section through another sheetlike composite 200 of the invention. The sheetlike composite 200 of FIG. 2b) is the sheetlike composite of FIG. 2a), except that in FIG. 2b) a polymeric external layer 209 made of polyethylene has been superposed onto the carrier layer 203, and the external surface 201 is therefore a surface of the polymeric external layer 209.

FIG. 3 is a diagrammatic cross section through a first component 300 of the invention. The first component 300 includes a first component surface 301, including a plurality of recesses 302. The first component 300 is an intaglio printing cylinder, and the first component surface 301 is a cylinder jacket surface of the intaglio printing cylinder. The recesses 302 are cells. The cells respectively include a composition 303. This is depicted in FIG. 3 in that the larger broken-line circle on the right-hand side of FIG. 3 is an enlarged view of the cell in the smaller broken-line circle on the left-hand side of FIG. 3. The composition 303 is a printing ink including a colourant. The colourant is a pigment. The intaglio printing cylinder moves in a first direction 304 in that it rotates in a first direction of rotation.

FIG. 4a) is a diagrammatic cross section through a printed sheetlike composite 400 of the invention. The printed sheetlike composite 400 consists of the following layers mutually superposed in this sequence from an external surface 201 of the printed sheetlike composite 400 to an internal surface 202 of the printed sheetlike composite 400: a colour layer 401; a carrier layer 203 made of paperboard, an LDPE layer 204, an adhesion-promoter layer 205, a barrier layer 206 made of aluminium, an EAA layer 207, and a polymeric internal layer 208. The polymeric internal layer 208 here consists of a polymer blend which includes 80% by weight of an mPE and 20% by weight of an LDPE, based in each case on the total weight of the polymer blend. The colour layer 401 includes a first colour layer region 402 and a further colour layer region 403. The first colour layer region 402 adjoins the further colour layer region 403. The first colour layer region is characterized by an area coverage of 80%. The further colour layer region is characterized by an area coverage of 5% of the same colour. The colour layer 401 is a decor of the printed sheetlike composite 400. This decor has improved area coverage contrast in relation to the abovementioned colour. The external surface 201 is a surface which belongs to the colour layer 401 and which faces away from the carrier layer 203. The external surface 201 is moreover that surface of the printed sheetlike composite 400 that faces outwards in a food container produced from the printed sheetlike composite 400. The internal surface 202 is that surface of the printed sheetlike composite 400 that faces inwards in a food container produced from the printed sheetlike composite 400, and accordingly is in contact with the food therein. The printed sheetlike composite 400 is in particular obtainable via printing of the sheetlike composite 200 of FIG. 2 according to the process 100 of FIG. 1 or with the aid of the device in FIG. 5, or both.

FIG. 4b) is a diagrammatic cross section through another printed sheetlike composite 400 of the invention. The printed sheetlike composite 400 of FIG. 4b) is the sheet of FIG. 4a), except that in FIG. 4b) there is a polymeric external layer 409 made of polyethylene located between the colour layer 401 and the carrier layer 203. The colour layer 401 has been printed onto the polymeric external layer 209.

FIG. 5 is a diagrammatic view of a device 500 of the invention. The device 500 is suitable for the printing of the sheetlike composite 200 of FIG. 2 with a decor by means of an intaglio printing process. In particular, the device 500 has been designed for the implementation of the process 100 of FIG. 1. The device 500 includes a sheetlike composite 200 of FIG. 2. The device 500 moreover includes a first component 300 which is an intaglio printing cylinder of FIG. 3. The intaglio printing cylinder here has been earthed by means of the earth 504. To this end it is in particular possible that a shaft which functions as axis of rotation of the intaglio printing cylinder is earthed. The intaglio printing cylinder moves in a first direction 304 in that the intaglio printing cylinder rotates in a first direction of rotation. The device 500 further includes a further component 501 which is a impression roll. The impression roll moves in a further direction 502 in that the impression roll rotates in a further direction of rotation. The further direction of rotation is opposite to the first direction of rotation. The impression roll is not earthed. The impression roll guides the sheetlike composite 200 in such a way that the external surface 201 of the sheetlike composite is forced onto the first component surface 301 with the recesses 302. The sheetlike composite 200 here is guided through a gap between the impression roll and the intaglio printing roll, and is thus printed. The device 500 further includes an electrode 502 arranged and designed in such a way that it applies electrons to the external surface 201 of the sheetlike composite 200. The situation applying to each subregion of the external surface 201 here is that electrons are first applied from the electrode 502 onto the subregion, and then the subregion is printed via contact with the intaglio printing roll. The sheetlike composite 200 has thus been negatively electrically charged, while the intaglio printing cylinder and the composition 303, which is a printing ink, are electrically neutral. Accordingly there are electrostatic attraction forces existing between the printing ink and the external surface 201 of the sheetlike composite 200. As shown in the enlarged region on the right-hand side in FIG. 5, the printing ink in the cells includes a convex surface, i.e. a surface curved outwards. Downstream of the intaglio printing roll and of the impression roll the device 500 includes an earth 504 which earths the sheetlike composite 200 after the printing procedure described above, and thus further reduces the electrical charge of the said sheet.

FIG. 6 is a diagrammatic view of a container precursor 600 of the invention. The container precursor 600 shown here is a jacket. The jacket includes a top region 602 and a base region 603. The top region 602 and the base region 603 respectively include crease lines 604. The top region 602 and the base region 603 can respectively be sealed by folding along the creases 604 and sealing, and a closed container 700 of FIG. 7 can thus be obtained from the jacket. Accordingly the container precursor 600 is a precursor produced in the process for producing the closed container 700. The container precursor 600 here includes a cut-to-size section of the sheetlike composite 400 of FIG. 4. In the container precursor 600 the sheetlike composite 400 has been folded; here it includes 4 folds 601. The jacket moreover includes a longitudinal seam 605 along which end regions of the sheetlike composite 400 have been sealed to one another.

FIG. 7 is a diagrammatic view of a closed container 700 of the invention. The closed container 700 can be obtained via folding of the container precursor 600 of FIG. 6 along the creases 604 and sealing of folded regions to seal the top region 602 and the base region 603. Accordingly the closed container 700 includes a cut-to-size section of the sheetlike composite 400 of FIG. 4. The closed container further includes at least 8 folds 601. The closed container 700 surrounds an internal space which includes a food 701. The food can be liquid, but can also include solid constituents. The closed container 700 shown in FIG. 7 is of one-piece design. The closed container can moreover be provided with a fitment to improve ease of opening. This is in particular the case when the carrier layer 203 of the sheetlike composite 400 has a hole.

FIG. 8 is a diagrammatic detail of an enlarged plan view of a colour layer 401 of a printed sheetlike composite 400 of the invention. The colour layer 401 has been obtained via printing by using the device 500 of FIG. 5, and consists of printed matrix dots 801. The printed sheetlike composite 400 consists of the following layers mutually superposed in this sequence from an external surface 201 of the printed sheetlike composite 400 to an internal surface 202 of the printed sheetlike composite 400: the colour layer 401, a polymeric external layer 209 made of LDPE Novex® M19N430 from Ineos Köln GmbH; a single paper-coating layer which can be obtained via coating with a liquid formulation comprising 100 parts of pigment (Hydrocarb 60; Omya Inc; Cincinnati, US) and 20 parts of binder/SB Latex (MAINCOTE™ HG-56; Dow; Germany); a carrier layer 203 made of NaturaD UC 200 mN, Stora Enso AB, Stockholm, Sweden; an LDPE layer 204 made of LPDE Novex® M19N430 from Ineos Köln GmbH; a barrier layer 206 made of aluminium EN A W 8079 from Hydro Aluminium Deutschland GmbH of thickness 6 μm; and a polymeric internal layer 208 made of a PE blend including 30% by weight of an mLDPE and 70% by weight of an LDPE, based in each case on the total weight of the polymeric internal layer 208, with weight per unit area 22 g/m². The colour layer 401 consists of a printed image obtained in the intaglio printing process, characterized by a matrix with 60 matrix dots per cm and area coverage 30%. The printed sheetlike composite 400 is further characterized by a layer thickness of 11 μm for the polymeric external layer 209 and an ignition residue of 30 mg according to the above test method. The colour layer 401 shown is further characterized by a number of 7 absent matrix dots 902 per 100 mm².

FIG. 9 is a diagrammatic detail of an enlarged plan view of a printed image 901 of a printed sheetlike composite 900 not of the invention. The printed image 901 was obtained via printing using the device 500 of FIG. 5, but with no use of the electrode 502 to charge the sheetlike composite 200. The printed image 901 was therefore not obtained according to the process 100 of the invention. The printed image 901 consists of printed matrix dots 801. The printed sheetlike composite 900 consists of the following layers mutually superposed in this sequence: the printed image 901; a polymeric external layer 209 made of LDPE Novex® M19N430 from Ineos Köln GmbH; a single paper-coating layer which can be obtained via coating with liquid formulation comprising 100 parts of pigment (Hydrocarb 60; Omya Inc; Cincinnati, US) and 20 parts of binder/SB Latex (MAINCOTE™ HG-56; Dow; Germany); a carrier layer 203 made of NaturaD UC 200 mN, Stora Enso AB, Stockholm, Sweden; an LDPE layer 204 made of LDPE Novex® M19N430 from Ineos Köln GmbH; a barrier layer 206 made of aluminium EN A W 8079 from Hydro Aluminium Deutschland GmbH of thickness 6 μm; and a polymeric internal layer 208 made of a PE blend including 30% by weight of an mLDPE and 70% by weight of an LDPE, based in each case on the total weight of the polymeric internal layer 208, with weight per unit area 22 g/m². The printed image 901 is characterized by a matrix with 60 matrix dots per cm and with area coverage 30%. The printed sheetlike composite 900 is further characterized by a layer thickness of 11 μm of the polymeric external layer 209 and an ignition residue of 30 mg according to the above test method. The printed image 901 shown is further characterized by a number of 45 absent matrix dots 902 per 100 mm².

### LIST OF REFERENCE NUMERALS

100 Process of the invention
101 Step a)
102 Step b)
103 Step c)
104 Step d)
200 Sheetlike composite
201 External surface
202 Internal surface
203 Carrier layer
204 LDPE layer
205 Adhesion-promoter layer
206 Barrier layer
207 EAA layer
208 Polymeric internal layer
209 Polymeric external layer
300 First component
301 First component surface
302 Recess
303 Composition
304 First direction
400 Printed sheetlike composite of the invention
401 Colour layer
402 First colour layer region
403 Further colour layer region
500 Device of the invention
501 Further component
502 Electrode
503 Further direction
504 Earth
600 Container precursor of the invention
601 Fold
602 Top region
603 Base region
604 Crease
605 Longitudinal seam
700 Closed container of the invention
701 Food
801 Printed matrix dot
900 Printed sheetlike composite not of the invention
901 Printed image not obtained according to the invention
902 Absent matrix dot

What is claimed is:

1. A process including, as steps,
a) provision of a sheetlike composite including, as mutually superposed layers, from an external surface of the sheetlike composite to an internal surface of the sheetlike composite,
i) a carrier layer,
ii) a barrier layer, and
iii) a polymeric internal layer,
wherein the sheetlike composite has a first electrical charge;
b) provision of a first component including a first component surface, wherein the first component surface includes a plurality of recesses, wherein the recesses include a composition including a colourant, wherein the first component moves in a first direction,
wherein the first component has a further electrical charge;
c) increase of the absolute magnitude of the difference between the first electrical charge and the further electrical charge; and
d) bringing the external surface of the sheet like composite into contact with the first component surface.

2. The process according to claim 1, wherein the process further includes a step of
e) reduction of the absolute magnitude of the difference between the first electrical charge and the further electrical charge downstream of the step d) (104).

3. The process according to claim 1, wherein the barrier layer is electrically insulating.

4. The process according to claim 1, wherein the increase in step c) is achieved via application of electrical charge carriers from an electrode onto the external surface of the sheetlike composite.

5. The process according to claim 1, wherein the barrier layer is electrically conductive.

6. The process according to claim 1, wherein the sheetlike composite is characterized by an ignition residue in the range from 0.1 to 75 mg.

7. The process according to claim 1, wherein the sheetlike composite further includes a polymeric external layer on one side of the carrier layer, wherein the said side faces towards the external surface, wherein a layer thickness of the polymeric external layer is in the range from 1 to 20μιη.

8. The process according to claim 1, wherein the sheetlike composite is superimposed by a colour layer on the external surface in step d),
wherein the colour layer is characterized by a number of absent matrix dots in the range from 0 to 100 per 100 mm².

9. A printed sheet like composite obtainable via the process according to claim 1.

10. A device including, as device constituents,
a) a sheetlike composite including, as mutually superposed layers, from an external surface of the sheetlike composite to an internal surface of the sheetlike composite,
i) a carrier layer,
ii) a barrier layer, and
iii) a polymeric internal layer;
b) an electrode arranged and designed for the transfer of electrical charge carriers onto the external surface of the sheet composite; and
c) a first component including a first component surface, wherein the first component surface includes a plurality of recesses, wherein the recesses include a composition including a colourant, wherein the first component surface has been brought into contact with the external surface of the sheet composite.

11. The device according to claim 10, wherein the device includes a further electrode downstream of the first component,
wherein the further electrode is arranged and designed for acceptance of electrical charge carriers from the external surface of the sheetlike composite.

12. A printed sheet like composite including, as mutually superposed layers, from an external surface of the printed sheetlike composite to an internal surface of the printed sheetlike composite,
i) a colour layer,
ii) a carrier layer,
iii) a barrier layer, and
iv) a polymeric internal layer,
wherein the printed sheetlike composite is characterized by an ignition residue in the range from 0.1 to 75 mg.

13. The printed sheetlike composite according to claim 12, wherein the sheetlike composite further includes a polymeric external layer between the colour layer and the carrier layer,
wherein the polymeric external layer is characterized by a layer thickness in the range from 1 to 20μιη.

14. A container precursor at least to some extent including the printed sheetlike composite according to claim 9.

15. A closed container at least to some extent including the printed sheet like composite according to claim 9,
wherein the printed sheetlike composite (400) has been folded at least once.

16. A use of the device according to claim 10 for printing of the sheetlike composite.
